(19) United States
(12) Patent Application Publication
(10) Pub. No.: US 2007/0222451 A1
(43) Pub. Date: Sep. 27, 2007

(54) METHOD AND APPARATUS FOR SHIMMING A MAGNETIC FIELD

(76) Inventors: Stuart Paul Feltham, Bicester (GB); Matthew Hobbs, Oxford (GB); Marcel Jan Marie Kruip, Oxford (GB)

Correspondence Address: SCHIFF HARDIN, LLP;PATENT DEPARTMENT, 6600 SEARS TOWER, CHICAGO, IL, 60606-6473, US

(21) Appl. No.: 11/677,593

(22) Filed: Feb. 22, 2007

(30) Foreign Application Priority Data
Mar. 21, 2006 (GB) 0605640.2

(51) Int. Cl. G01V 3/00

(52) U.S. Cl. 324/320; 324/306; 324/318

(57) ABSTRACT

An apparatus for shimming the magnetic field generated by a magnet arrangement of a magnetic resonance imaging (MRI) system, has a number of shim devices of substantially similar cross-sectional dimensions, at least some of the shim devices exhibiting differing ferromagnetic characteristics. A structure body has an elongate, tubular channel cross-sectionally dimensioned to serially receive the shim devices in a predetermined sequence to provide a required distribution of the ferromagnetic characteristics in relation to said magnetic field, the channel being of length sufficient to accommodate the shim devices serially in said predetermined sequence. The shim devices are presented at the entrance of the channel in the sequence, and are forced into the channel in the sequence by pressurized fluid directed toward the entrance.

### BACKGROUND OF THE INVENTION

1. Field of the Invention

The present invention relates to apparatus for and methods of improving the homogeneity of magnetic fields generated by the magnet arrangements utilized in magnetic resonance imaging (MRI) systems, and it relates especially, though not exclusively, to such apparatus and methods for open-magnet MRI systems. The invention also encompasses the provision of shims incorporated in such apparatus and utilized in such methods.

2. Description of the Prior Art

It is well known that, in order to achieve, over the field of view (FOV) of an MRI system, the high degree of field homogeneity required of the powerful magnetic fields employed, corrective measures need to be taken, since the fields as generated by the magnets tend to be inhomogeneous to an unacceptable extent.

A common and effective corrective measure involves the measurement of the field characteristics to reveal its degree of spatial homogeneity, the calculation of field distortion necessary to correct inhomogeneities to a prescribed extent, and the provision of a distributed array of individual pieces of ferromagnetic material, such as sheet steel or iron, with differing ferromagnetic characteristics, at a convenient position in relation to the magnet structure and the FOV of the MRI system to provide the required field distortion. These pieces of ferromagnetic material are known as “shims”, and their differing ferromagnetic characteristics may, for example, result from the use of shims of varying thicknesses. In any event, shims having appropriate ferromagnetic characteristics to achieve the desired spatial field distortion are selected and placed so as to distort the generated magnetic field in a sense such as to improve the homogeneity of the magnetic field across the FOV; the corrective process as a whole being referred to as “shimming”.

Typically in practice, shims selected as described above, and in accordance with the desired corrective procedure, are placed within respective pockets in a tray, called a “shim tray”, which is slid into a receiving slot until located as desired, and several trays are typically deployed, in respective receiving slots, so as to surround the FOV. Such an arrangement is disclosed, for example, in WO 2005/114242 A2, the disclosure of which is incorporated herein by reference.

### SUMMARY OF THE INVENTION

A general difficulty which is encountered with shimming process is that of ensuring that shims having the correct ferromagnetic characteristics are loaded into the correct pocket locations in the shim trays, and one object of the invention is to reduce or eliminate this difficulty.

The principal object of the invention, however, is to address a difficulty which is particularly problematic in open-magnet MRI systems, as opposed to the closed, solenoidal magnet systems utilized in MRI systems of the kind described in the aforementioned international patent application. In this respect, closed magnet systems provide relatively straightforward access to the receiving slots for the shim trays, since the receiving slots can be conveniently disposed and presented to the front or the rear of the MRI system. Such a system is shown schematically in FIG. 1, wherein a superconducting magnet and cryostat assembly 1 surrounds a set of gradient coils 2 and the location of the shim tray is shown at 3.

Particular difficulties arise, however, in implementing such a shimming procedure in MRI systems utilizing open magnet configurations, wherein the magnets used are non-solenoidal and have substantially flat pole-pieces. FIGS. 2, 3 and 4 show various open magnet systems, in cross-sectional view, and in general outline. In particular, FIG. 2 shows schematically a system utilizing a “C” magnet 11, with a resistive coil arrangement 12 as the field generator; the shim tray location being shown at 3a.

FIG. 3 shows a system in which the field is generated by a disc 13 of permanent magnetic material, the shim tray being disposed as shown at 3b, and FIG. 4 shows a system in which the magnetic field is generated by superconducting coils such as 14 supported on suitable formers, the shim tray location being shown at 3c.

All of these open magnet systems utilize a so-called “Rose Ring” 15, or an alternative feature to control field uniformity at the periphery of the magnet system, which ring or feature prohibits (or at least renders difficult and time-consuming) radial access to the shim trays 3a, 3b or 3c.

The shim trays 3a, 3b, 3c are typically positioned between gradient coils of the system and the respective pole-faces, so the shimming procedure in open-magnet MRI systems requires the removal of the gradient coil set; the significant weight of which creates handling difficulties, and moreover requires additional measures to be taken to assure that accurate and repeatable repositioning of the gradient coils can be achieved.

A cross section through a typical planar gradient coil set is shown in FIG. 5. The gradient coils consist of a so called primary coil set 51, which comprises: one X-direction gradient coil set, one Y-direction gradient coil set and one Z-direction gradient coil set. The stray fields of this primary gradient coil set will interact with the conducting surfaces in the pole face or the cryostat. To limit these fields, a so called secondary gradient coil set 52 may be included for some or all of the X-, Y-, or Z-directions, which includes at least a secondary coil set for the gradient coil with the most perturbing primary gradient coil, Preferably, to limit relative movement and to facilitate assembly, the primary and secondary gradient oil sets 51, 52 impregnated and encapsulated within a resin encapsulant 53.

Some space 54 is required between the primary and secondary gradient coils to make the shielded gradient coils work at acceptable power levels because, unless sufficient space is provided, the coils start to compete with each other for power, at the expense of a high dissipation. This space is typically filled with a region of solid encapsulant during the coil impregnation process.

A shim set 55 is typically provided on the FOV side of the encapsulated gradient coils, with a corresponding RF coil 56 placed on the FOV side of the shim set. The shim set and the RF coils are typically placed beyond the Rose ring 15, in the direction of the FOV, to allow access to the shim set. While it would be functionally preferable to locate the shim set within the space 54 between primary and secondary gradient coils, this is generally not done since access to the shim set for shimming would require mechanical displacement of the Rose ring and at least the primary gradient coil.

It is thus an object of the present invention to provide apparatus and methods for shimming open-magnet magnetic resonance imaging (MRI) systems which addresses the foregoing difficulties, and it is a further object to provide shims for use in the apparatus and method, and an MRI system utilizing such shims.

According to the invention an apparatus for shimming the magnetic field generated by a magnet arrangement of an MRI system has a number of shim devices of substantially similar cross-sectional dimensions, at least some of the shim devices exhibiting differing ferromagnetic characteristics. A structural body has an elongate, tubular channel therein that is cross-sectionally dimensioned to serially receive said shim devices in a predetermined sequence to provide a required distribution of the ferromagnetic characteristics in relation to said magnetic field; the channel being of length sufficient to accommodate said shim devices serially in the predetermined sequence. The apparatus further includes an arrangement for inserting the shim devices serially, in said predetermined sequence, into the receiving channel, an arrangement that directs fluid, either gas or liquid, under pressure toward an entrance to said receiving channel, and a predetermined unit that presents the shim devices serially, in the predetermined sequence, at said entrance, whereby the fluid pressure forces the shim devices serially into the channel.

In a particularly preferred apparatus, the presentation unit automatically presents the shim devices in the predetermined sequence at the entrance.

The magnetic resonance imaging (MRI) system may advantageously be an open-magnet magnetic resonance imaging (MRI) system.

The tubular receiving channel may be cross-sectionally dimensioned to receive shim devices of any predetermined shape, such as spherical, cylindrical, rectangular, triangular or hexagonal, for example.

Preferably, the shim devices comprise respective ferromagnetic core portions of selected dimensions, each individually encapsulated in a non-magnetic and non-electrically conductive shell. In this way, the individual shim devices, once serially loaded into the receiving channel, can be held reliably in position therein by contact between adjacent shells. End shim devices of slightly larger dimensions may be used, if desired, to firmly close the end of a receiving channel. Alternatively, suitably shaped closures, preferably incorporating resilient pads (or other suitable resilient means) to apply end-pressure to the assembled shim devices, can be utilized.

Since the individual shim devices, as encapsulated, tend to be difficult to distinguish from one another as to their ferromagnetic properties, it is preferred that the devices bear visual indications as to the size and/or other ferromagnetic characteristics of the ferromagnetic material incorporated therein. Such visual indication may be provided, for example, by color coding (for example, colored rings may be used, of similar kind to those employed to indicate the values of resistors), by numeric and/or alphabetic indicators, by surface processing, by bar coding or in any other convenient manner. Combinations of such indications may be used if desired.

Mixtures of differently shaped shim devices can be utilized in a single receiving channel if desired; for example spherical devices may be mixed with cylindrical devices of similar radius, and the cylindrical devices may have a common length or an array of lengths. Such shaping can be used as part or all of an identification system to assist differentiation between shim devices of differing ferromagnetic characteristics.

The receiving channels may be provided as separate entities into which the shim devices can be loaded before or after installation into the MRI magnet system. Alternatively, the channels may be passageways molded or otherwise created within the magnet system or encapsulants therefor, and the shim devices loaded into them.

Whether the receiving channels are separate entities or formed in-situ, they may be straight or they may meander in one or more planes to provide an extended enclosure.

The effectiveness of the shim tray increases rapidly the closer the shim devices are disposed to the FOV. This is particularly significant for magnets such as those shown in FIG. 4, which tend to utilize a high central field, typically in excess of 0.6 T. In this case it is desirable to have the shim tray as close to the FOV as possible. However, in current constructions, the gradient coils occupy the space nearest to the FOV because the gradient coils should be positioned as far away from conducting surfaces (such as the pole tips) as possible.

### DESCRIPTION OF THE DRAWINGS

FIGS. 1 to 4, as noted above, schematically represent different types of known magnet arrangements.

FIG. 5 shows a typical gradient coil layout and illustrates the location of a receiving channel therein for shim devices of the invention;

FIGS. 6A and 6B show an arrangement of, and method for forming, receiving channels according to an embodiment of the present invention;

FIG. 7 shows, in partially cut-away view, one example of a shim device for use in apparatus according to one embodiment of the invention;

FIG. 8 shows another example of a shim device for use in apparatus according to an embodiment of the invention;

FIG. 9 shows a further example of a shim device for use in apparatus according to another embodiment of the invention; and

FIG. 10 shows a gradient coil layout and illustrates the location of a receiving channel therein for shim devices of the invention, and the arrangement of shim providing device for introducing shim devices into receiving channels.

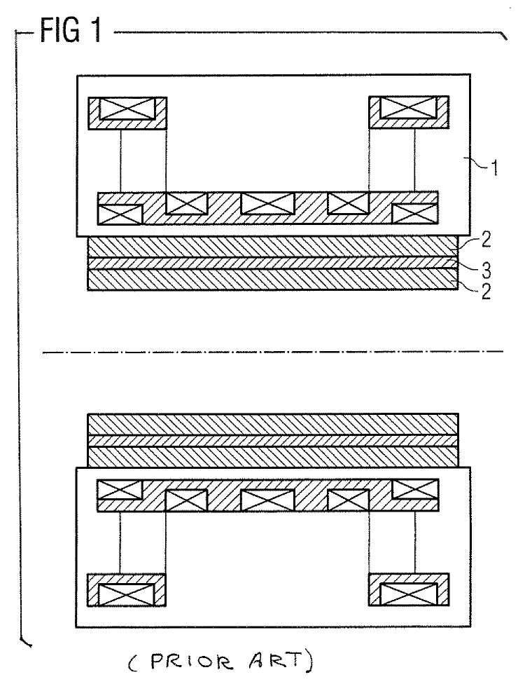

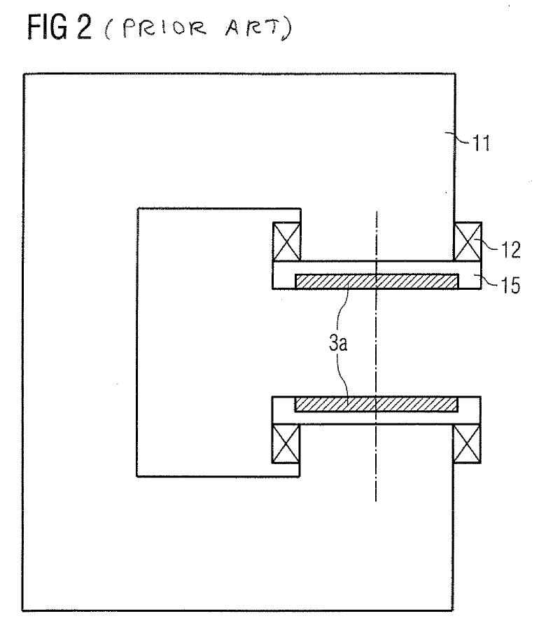

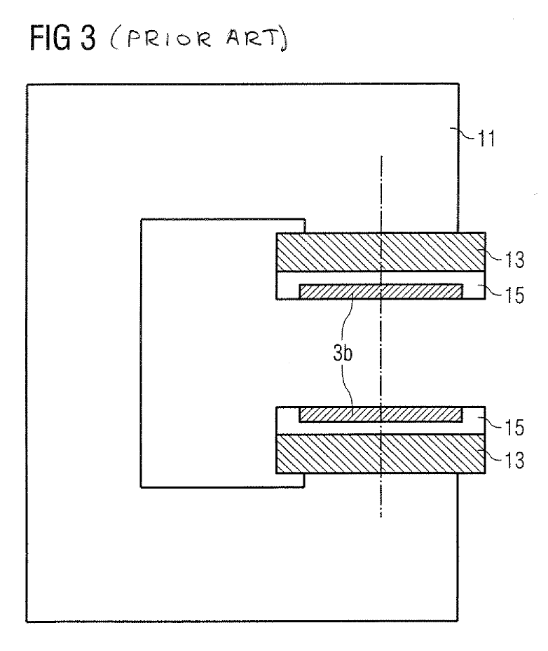

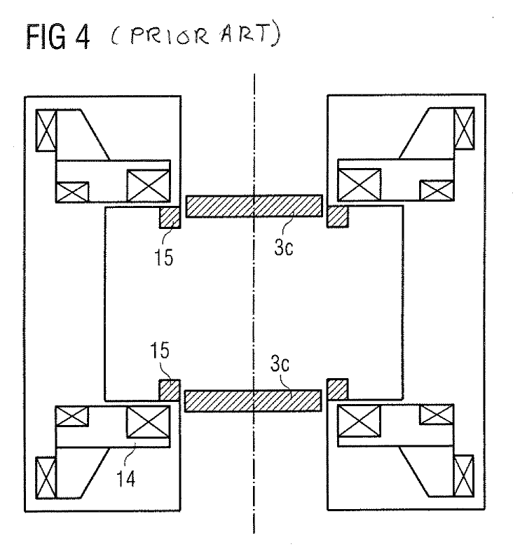

### DESCRIPTION OF THE PREFERRED EMBODIMENTS

The invention will be described hereinafter in the context of an open-magnet magnetic resonance imaging (MRI) system, and it will be understood that the gradient coil assemblies in such systems are usually planar in shape. A cross section through a typical planar gradient coil set is shown in FIG. 5.

As discussed earlier, the gradient coils are formed as a so called primary coil set 51, which includes one X-direction gradient coil set, one Y-direction gradient coil set and one Z-direction gradient coil set. The stray fields of this primary gradient coil set will interact with the conducting surfaces in the pole face or the cryostat. To limit these fields, a so called secondary gradient coil set 52 may be included for some or all of the X-, Y-, or Z-directions, which includes at least a secondary coil set for the gradient coil with the most perturbing primary gradient coil, Preferably, to limit relative movement and to facilitate assembly, the primary and secondary gradient oil sets 51, 52 impregnated and encapsulated within a resin encapsulant 53.

Some space 54 is required between the primary and secondary gradient coils to make the shielded gradient coils work at acceptable power levels because, unless sufficient space is provided, the coils start to compete with each other for power, at the expense of a high dissipation. This space is typically filled with a region of solid encapsulant during the coil impregnation process.

In a preferred embodiment of the present invention, provision is made for a channel for the insertion of shimming devices in the space 54 between the primary and the secondary gradient coils. It is preferred that the receiving passages for the shim devices are formed within the structure of the magnet assembly. The receiving channels have a cross-sectional diameter which is slightly larger than the diameter of shim devices to be inserted therein, described below.

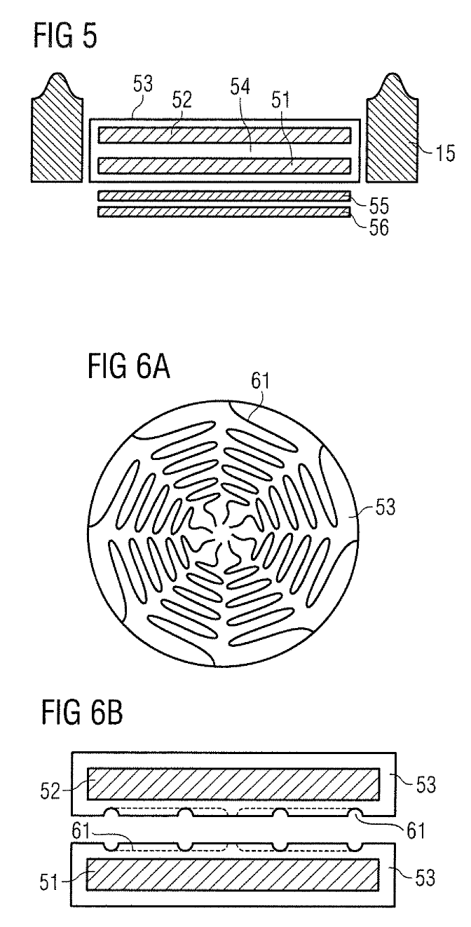

In an example embodiment, illustrated in FIGS. 6A and 6B, receiving channels 61 for shim devices may be formed within the encapsulant 53 filling the space 54. As shown in FIG. 6A, such receiving channels 61 may be arranged in serpentine form, repeated in segments around the area of the gradient coils. Many alternative configurations of receiving channels are of course possible, such as spiral configurations, straight radial configurations or arrangements of straight or curved, parallel receiving channels.

As shown in FIG. 6B, the receiving channels may conveniently be formed by encapsulating the primary and secondary gradient coils separately, in suitably shaped moulds. The separate encapsulated coils may then be bonded together to define the receiving channels. Alternatively, suitably shaped pieces of a sacrificial fugitive material such as paraffin wax may be included within the space 54 when the coils are impregnated and encapsulated. When encapsulation is complete, the resultant structure is heated above the melting point of the fugitive material, which escapes to leave receiving channels of the desired configuration.

For receiving channels of an appropriate configuration, it may be possible to create them within a solid block of encapsulant by machining processes.

In some circumstances, however, for example where it is not possible to create a channel with sufficient precision, the shim devices may be pre-loaded into an elongate, tubular envelope of non-ferromagnetic material, and the entire assembly pushed into place in the magnet system.

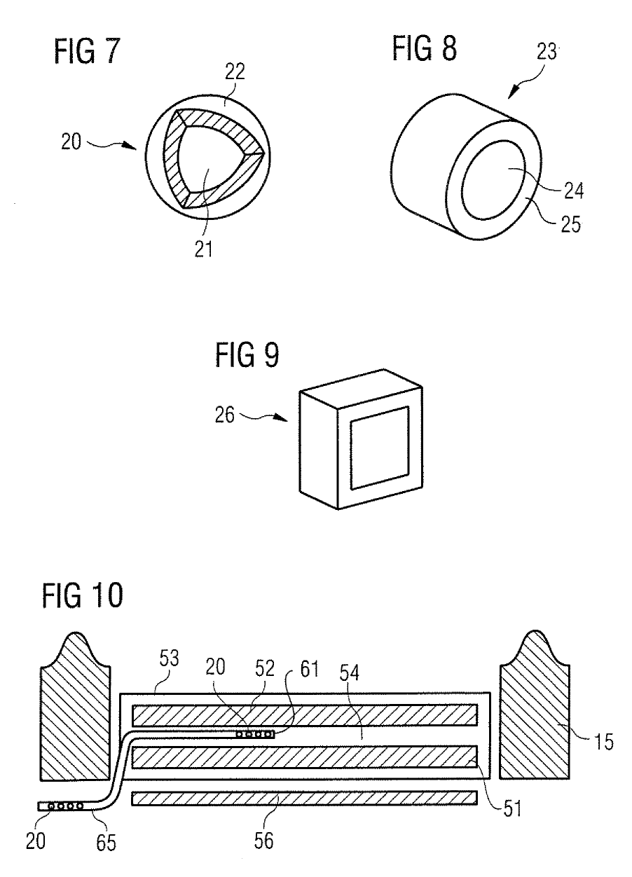

As regards the nature of the shim devices themselves, a first, and preferred, embodiment, provides shim devices 20 in the form of ferromagnetic spheres, such as a ball bearing 21 coated with an insulator 22 as shown in FIG. 7, which shows an insulated shim device in the form of a ball with the insulation 22 shown partially removed for illustrative purposes. According to an aspect of the present invention, the shims such as 20 are inserted in one or more elongate, tubular, receiving channels, preferably situated between the primary and secondary coil sets, as described above.

The tubular receiving channels have a cross-sectional diameter which is slightly larger than the diameter of the insulated shim devices such as 20. The entrance of the receiving channel has a diameter equal or larger than the general cross-sectional diameter of the channel. The other end of the channel can be ‘blind’ (i.e. totally closed) or it can be provided with an opening to ambient atmosphere; the opening of course having a diameter less than that of the shim devices such as 20. The channel may also be a through-channel, open to receive shim devices at both ends. Such an arrangement would be particularly suitable for receiving channels formed as parallel straight channels.

The entrance of the shim-receiving channel can be through the Rose rings and/or at 90 degrees from the main body of the shim-receiving channel. This allows the channel entrance to be placed in the face of the gradient coil at a position where there is no conductor.

One or more receiving channel can have one or more bends, causing it to meander in one or more planes, depending upon the overall configuration of the MRI magnet system. Moreover, any given shim volume can incorporate one or more shim-receiving channels.

FIG. 10 illustrates a possible arrangement of a receiving channel 61 in an embodiment of the present invention. The advantage of such an arrangement if that the shims provided by the present invention may be arranged in a plane between the two gradient coils, within the Rose ring, without needing to mechanically remove any pieces of equipment. The shim devices are simply driven, as required, into the channels to come to rest at the respective required position. A shim device presentation unit is schematically illustrated at 65, in the process of introducing shim devices 20 into receiving channel 61.

The shim devices such as 20 can exhibit a range of different ferromagnetic characteristics (e.g. strength), depending inter alia on the diameter and/or material of the inner ferromagnetic ball 21. The diameter of the ferromagnetic ball can be zero, in which case the shim device constitutes a pure insulator, providing no shimming effect in itself but enabling the correct positioning of other shim devices within the receiving channels.

It will be appreciated from the foregoing that the shimming procedure consists of: 1) a field mapping step; 2) a process in which the required distribution of shim material is calculated; and 3) the insertion of the shim material in a predetermined distribution determined by the first two steps. In some cases, the steps 1), 2) and 3) above need to be repeated once or more in order to iteratively approach a homogeneity correction setup that meets all requirements.

In a preferred embodiment, the shim devices may be inserted into the receiving channels by forcing ball-like shim devices such as 20 into a receiving channel serially, and in the predetermined sequence, by means of compressed air or some other suitable fluid under pressure. In such an arrangement, ball-like devices 20 are serially presented, in a pre-selected sequence consistent with the required distribution of material calculated in step 2) of the above-outlined procedure, at the entrance of the channel, and the nozzle of a compressed air supply is utilized to blow the devices 20 into the channel. Each ball-like device 20 will move until it reaches the end of the channel, or until it hits the previous shim device inserted. This, and the confines of the shim-receiving channel, accurately defines the position of the shim layout.

In another embodiment, the loading process can be accelerated by arranging an array of ball-like shim devices such as 20 in the correct, predetermined sequence, in a holding tube. One opening of this holding tube is placed at the entrance of the shim-receiving channel, and compressed air (or other fluid) or mechanical pressure is applied to the other end of the holding tube such that the entire sequence of ball-like shim devices 20 is transferred from the holding tube into the shim-receiving channel.

In another embodiment, the loading of shim devices into a shim-receiving channel is carried out by means of an apparatus having a number of hoppers, each filled with ball-like shim devices having a respective common ferroelectric characteristic, a computer controlled switch and a compressed air supply. When activated, the apparatus releases ball-like shim devices of appropriate ferroelectric characteristics in the right order into the shim-receiving channel. The order of loading is calculated by the computer, based on the results of the field map. This has the important advantage that no manual handling of shims is required, thus avoiding a common source of error in current shim-loading procedures which is generic to both open- and closed-magnet magnetic resonance imaging (MRI) systems.

Subject to health and safety provisions, any other compressed gas can, of course, be used instead of compressed air to propel the shim devices into shim-receiving channels. Alternatively, certain liquids may be used, provided that a suitable liquid flow circuit can be established, for example by coupling the end of the shim-receiving channel farthest from the insertion point to a liquid reservoir at lower pressure.

In another embodiment, shim devices such as that shown in FIG. 8 at 23 can consist of or include a cylindrical ferromagnetic shimming core 24, surrounded by cylindrical insulation 25. If the cross section of the tubular, shim-receiving channel is circular, with an inner diameter slightly bigger than the outside diameter of the cylindrical shim 23, such a shim can only inserted in a relatively straight channel, without significant bends.

The shim-receiving channel can be given a rectangular cross section, in which case a 90 degree bend is possible. The shims could be presented axially, one circular end first, into a receiving channel of circular cross-section. Alternatively, the shims could be presented radially, to roll along a receiving channel of rectangular cross section.

The shims can alternatively, or in addition, have a prismatic shape as shown at 26 in FIG. 9.

It will be appreciated that the shape of the ferromagnetic shimming core need not correspond to the shape of the overall shim device. Thus a ball-like core may be encapsulated within a cylindrical shell, for example, or vice-versa. Moreover, in shim devices exhibiting a range of ferroelectric characteristics, there may be at least one device which comprises only a ferromagnetic core, i.e. with no encapsulant shell.

Amongst the advantages exhibited by the invention are the capability for insertion of shim material where access is limited; and compatibility with a fully automatic shimming procedure. The invention further allows the use of space 54 between primary 51 and secondary 52 planar gradient coils, thus enabling shims to be positioned closer to the FOV than is the case with the present art. The invention additionally allows shimming in channels which can be curved in a non planar way.

Although modifications and changes may be suggested by those skilled in the art, it is the intention of the inventors to embody within the patent warranted hereon all changes and modifications as reasonably and properly come within the scope of their contribution to the art.

We claim as our invention:

1. An apparatus for shimming a magnetic field generated by a magnet arrangement, said apparatus comprising:
a plurality of shim devices of substantially similar cross-sectional dimensions, at least some of said shim devices exhibiting different ferromagnetic characteristics from others of said shim devices;
a structural body having an elongate, tubular channel therein having a cross-sectional dimension to serially receive said shim devices in a predetermined sequence to produce a predetermined distribution of said ferromagnetic characteristics with respect to said magnetic field, said channel having an entrance into which said shim devices are insertable and a length sufficient to accommodate said shim devices serially in said predetermined sequence; and
an insertion arrangement that inserts said shim devices serially, in said predetermined sequence, into said channel, said insertion arrangement comprising a pressurized fluid emitter that directs pressurized fluid toward said entrance of said receiving channel, and a presentation unit that presents said shim devices serially, in said predetermined sequence, at said entrance to cause said pressurized fluid to force said shim devices serially into said channel.

2. An apparatus as claimed in claim 1 wherein said presentation unit automatically presents said shim devices in said predetermined sequence at said entrance.

3. An apparatus as claimed in claim 1 wherein at least one of said shim devices has a ferromagnetic core of selected dimensions, encapsulated in a non-magnetic and non-electrically conductive shell.

4. An apparatus as claimed in claim 1 wherein one of said plurality of shim devices forms a final shim device in said predetermined sequence that enters last into said channel, said final shim device having dimensions larger than all other shim devices in said plurality of shim devices to plug said entrance of said channel.

5. An apparatus as claimed in claim 1 comprising a closure element for said channel, said closure element exerting a resilient end-pressure to the shim devices in said channel.

6. An apparatus as claimed in claim 1 wherein each of said shim devices has a visual indicator thereon identifying at least one ferromagnetic characteristic of that shim device.

7. An apparatus as claimed in claim 6 wherein said visual indicator is an indicator selected from the group consisting of colors, alphanumeric characters, surface processing, and bar coding.

8. An apparatus as claimed in claim 1 wherein at least some of said shim devices in said plurality of shim devices have respectively different geometric shapes.

9. An apparatus as claimed in claim 1 wherein said channel has a serpentine configuration in said structural body in at least one plane.

10. An magnetic resonance imaging apparatus comprising:
a basic field magnet that generates a magnetic field; and
an apparatus for shimming said magnetic field comprising a plurality of shim devices of substantially similar cross-sectional dimensions, at least some of said shim devices exhibiting different ferromagnetic characteristics from others of said shim devices, a structural body having an elongate, tubular channel therein having a cross-sectional dimension to serially receive said shim devices in a predetermined sequence to produce a predetermined distribution of said ferromagnetic characteristics with respect to said magnetic field, said channel having an entrance into which said shim devices are insertable and a length sufficient to accommodate said shim devices serially in said predetermined sequence, and an insertion arrangement that inserts said shim devices serially, in said predetermined sequence, into said channel, said insertion arrangement comprising a pressurized fluid emitter that directs pressurized fluid toward said entrance of said receiving channel, and a presentation unit that presents said shim devices serially, in said predetermined sequence, at said entrance to cause said pressurized fluid to force said shim devices serially into said channel.

11. A magnetic resonance imaging apparatus as claimed in claim 10 wherein said presentation unit automatically presents said shim devices in said predetermined sequence at said entrance.

12. A magnetic resonance imaging apparatus as claimed in claim 10 wherein at least one of said shim devices has a ferromagnetic core of selected dimensions, encapsulated in a non-magnetic and non-electrically conductive shell.

13. A magnetic resonance imaging apparatus as claimed in claim 10 wherein one of said plurality of shim devices forms a final shim device in said predetermined sequence that enters last into said channel, said final shim device having dimensions larger than all other shim devices in said plurality of shim devices to plug said entrance of said channel.

14. A magnetic resonance imaging apparatus as claimed in claim 10 comprising a closure element for said channel, said closure element exerting a resilient end-pressure to the shim devices in said channel.

15. A magnetic resonance imaging apparatus as claimed in claim 10 wherein each of said shim devices has a visual indicator thereon identifying at least one ferromagnetic characteristic of that shim device.

16. A magnetic resonance imaging apparatus as claimed in claim 15 wherein said visual indicator is an indicator selected from the group consisting of colors, alphanumeric characters, surface processing, and bar coding.

17. A magnetic resonance imaging apparatus as claimed in claim 10 wherein at least some of said shim devices in said plurality of shim devices have respectively different geometric shapes.

18. A magnetic resonance imaging apparatus as claimed in claim 10 wherein said channel has a serpentine configuration in said structural body in at least one plane.

19. A magnetic resonance imaging apparatus as claimed in claim 10 wherein said basic field magnet is an open magnet system.

20. A magnetic resonance imaging apparatus as claimed in claim 10 wherein said structural body is a component of said basic field magnet.

21. A magnetic resonance imaging apparatus as claimed in claim 10 wherein said structural body is separable from said basic field magnet to allow loading of said shim devices in said channel at or remote from said basic field magnet.

22. A method for shimming a magnetic field generated by a magnet arrangement, comprising the steps of
providing a plurality of shim devices of substantially similar cross-sectional dimensions, at least some of said shim devices exhibiting different ferromagnetic characteristics from others of said shim devices;
presenting said shim devices in a predetermined sequence to an entrance of an elongate, tubular channel therein having a cross-sectional dimension that serially receives said shim devices in a predetermined sequence therein to produce a predetermined distribution of said ferromagnetic characteristics with respect to said magnetic field; and
directing pressurized fluid toward said entrance of said receiving channel to force said shim devices serially into said channel in said predetermined sequence.
